(19) United States
(12) Patent Application Publication
(10) Pub. No.: US 2008/0075061 A1
(43) Pub. Date: Mar. 27, 2008

(54) Synchronising base stations

(75) Inventors: Edward Hatala, Devizes (GB); Peter Keevill, Bath (GB)

Correspondence Address: BEYER WEAVER LLP, P.O. BOX 70250, OAKLAND, CA, 94612-0250, US

(73) Assignee: Ubiquisys Limited

(21) Appl. No.: 11/897,006

(22) Filed: Aug. 27, 2007

(30) Foreign Application Priority Data
Aug. 29, 2006 (GB) 0617004.7

(51) Int. Cl. H04J 3/06

(52) U.S. Cl. 370/350

(57) ABSTRACT

A method for synchronising a clock signal in a basestation of a wireless telecommunications system is described. The basestation has a reference clock signal and is operable to communicate with wireless mobile terminals and with a packet switched network. The method comprises detecting a radio frequency clock synchronisation signal from a wireless telecommunications network, and synchronising the reference clock signal of the basestation in dependence upon the detected radio frequency clock synchronisation signal.

The present invention relates to synchronising base stations in wireless telecommunications systems.

### BACKGROUND OF THE INVENTION

Wireless telecommunications systems make use of basestations which communicate with mobile terminals using a radio frequency air interface. Such systems typically have many basestations communicating with many more mobile terminals. In order to connect communications from a mobile terminal to another user, the basestations communicate with an operator's network, typically using a circuit switched network. This network is often known as a “backhaul” network.

In order that mobile terminals and basestations are able to communicate with one another, and for one basestation to handover communication with a mobile terminal to another basestation, it is important that internal clock signals in the basestations are synchronised with one another and with the network.

Existing basestations use expensive oven controlled crystal oscillators to maintain a stable reference clock signal. However, over time the reference clock signal will drift from its nominal value, resulting in service deterioration, such as a mobile terminal not being able to connect to the network. To counteract the drift in reference clock signal, synchronisation signals are sent from a highly accurate and stable master clock source in the network. In existing time division multiplexed (TDM) backhaul networks, this clock is distributed to the basestations as embedded pulses at the physical “wire” level. These synchronisation pulses are used to “pull-in” or keep the basestation crystal oscillator within specification. In the US, some networks basestations are synchronised to signals derived from GPS (Global Positioning System) signals.

FIG. 1 of the accompanying drawings shows synchronisation boundaries of a circuit switched network 1 which includes a core network top-level clock 10. This top-level clock sets the timing reference for the whole system, and its output is transferred to the network via a Primary Reference Clock (PRC) 12. In this example, a synchronous digital hierarchy (SDH) network 14 is used to transfer data between the core network and a radio network controller (RNC) 16, as is well known. The RNC 16 communicates with basestations 20a, 20b, and 20c via a Plesiochronous Digital Hierarchy (PDH) network 18. Leased lines can provide the PDH network 18, for example.

A recent development in the provision of mobile radio networks provides residential basestations, which are smaller and lower cost than existing large scale designs, for communicating with wireless mobile terminals. Such residential basestations make use of existing broadband fixed line connections as the backhaul network. Such broadband networks are typically provided by Internet Protocol (IP) based networks, for example an ADSL (Asynchronous Digital Subscriber Line) network.

However, such IP based networks typically do not make use of timing synchronisation signals. This means that the reference clock signal of the residential is likely to drift out of frequency specification, especially because residential basestations generally will make use of a less highly specified crystal oscillator than that used for the usual wireless network basestation.

Existing data applications running over IP networks do not require nor provide synchronisation pulses, as the layer 2 protocol encapsulating IP performed this task. In the case of an ADSL backhaul network the Point-to-Point Protocol (PPP) layer 2 protocol is used to frame IP data. In turn, PPP is framed by the Asynchronous Transfer Mode (ATM) Adaptation Layer 5 (ML5), for transport over the ATM network between the ISP and ADSL modem PPP termination point in the home. Whilst the ADSL modems have reference clock signals which are adjusted to synchronise to the incoming ADSL physical level signals, these do not provide sufficient precision for use as a reference clock signal for a wireless basestation.

Although some mechanisms exist to provide time synchronisation over an IP network, for example as Network Time Protocol (NTP), none exist that provide sufficient accuracy for a basestation to attain and remain within frequency specification suitable for the wireless communications system. Furthermore, the methods that do exist rely on a return signalling path from the remote equipment to the NCS—a residential basestation deployment of thousands or millions of devices could create overwhelming amounts of return traffic to the NCS. Such large amounts of return data would limit the scalability of such a system. In particular, in ADSL connections the return path to the network is often of significantly lower bandwidth than the forward path, and so unnecessary traffic on the return link is particularly undesirable.

Drift in the reference clock signal can also occur with changes in temperature. Again, whilst methods for compensating for reference clock signal drift with temperature compensation exist, the degree of accuracy for the price is prohibitive for the residential market.

GSM and W-CDMA cellular network Base Stations are required to operate at the same frequency (within a given tolerance), although a delay between clock signals can be tolerated.

### SUMMARY OF THE PRESENT INVENTION

According to one aspect of the present invention, there is provided a method for synchronising a clock signal in a basestation of a wireless telecommunications system, the basestation having an internal reference clock signal and being operable to communicate with wireless mobile terminals and with a packet switched network, the method comprising detecting a radio frequency clock synchronisation signal from a wireless telecommunications network, and synchronising the reference clock signal of the basestation in dependence upon the detected radio frequency clock synchronisation signal.

Such a method can also comprise configuring at least part of the basestation as a mobile terminal operable to obtain clock synchronisation information from a standard wireless telecommunications network. In such a case, the method can comprise reconfiguring said part of the basestation as a wireless basestation following detection of the radio frequency clock synchronisation signal.

The radio frequency clock synchronisation signal may be detected from a wireless network different to the wireless network to which the basestation is connected.

The method may comprises receiving clock synchronisation data packets from the packet switched network, and synchronising the reference clock signal using the radio frequency clock synchronisation signal in combination with the received clock synchronisation data packets.

In such a case, the method may comprise initially synchronising the reference clock signal using the detected radio frequency clock synchronisation signal, and subsequently using received clock synchronisation data packets to maintain reference clock synchronisation, wherein a radio frequency clock synchronisation signal is detected and used for synchronisation if receipt of the clock synchronisation data packets is interrupted.

In a method in which synchronisation packets are received, then synchronising the reference clock frequency using received clock synchronisation packets may include the steps of receiving a start data packet at the basestation, starting a timer upon receipt of the start data packet receiving a stop data packet at the basestation, stopping the timer upon receipt of the stop data packet to generate a timer value, obtaining timestamp information at the basestation, the information including a time indication of time period between the sending of the start data packet and the sending of the stop data packet, comparing the timestamp information with the timer value to produce a comparison value, and adjusting the reference frequency of the basestation in dependence upon the generated comparison value.

Preferably, the basestation does not transmit feedback data packets to the packet switched network following reception of clock synchronisation data packets therefrom.

The packet switched network may be an Internet protocol based network.

According to another aspect of the present invention, there is provided a basestation for use in a wireless telecommunications system, the basestation having a reference clock signal and being operable to communicate with wireless mobile terminals and with a packet switched network, and comprising:
a detector for detecting a radio frequency clock synchronisation signal from a wireless telecommunications network; and
a synchronisation unit operable to synchronise the reference clock signal of the basestation in dependence upon a detected radio frequency clock synchronisation signal.

According to another aspect of the present invention, there is provided a method for synchronising a clock signal in a basestation of a wireless telecommunications system, the basestation having a reference clock signal, and being operable to communicate with wireless mobile terminals and with a packet switched network, the method comprising receiving clock synchronisation data packets transmitted from the packet switched network, and synchronising the reference clock signal of the basestation in dependence upon the received clock synchronisation packets, wherein the method does not include transmitting feedback data packets to the packet switched network from the basestation in response to receipt of clock synchronisation data packets therefrom.

According to another aspect of the present invention, there is provided a basestation for use in a wireless telecommunications system, the basestation having an internal reference clock signal, and being operable to communicate with wireless mobile terminals and with a packet switched network, and comprising a synchronisation unit operable to receive clock synchronisation data packets transmitted from the packet switched network, and to synchronise the reference clock signal of the basestation in dependence upon received clock synchronisation packets, synchronising the reference clock signal does not require transmission of feedback data packets to the packet switched network.

A number of novel approaches will be described that deliver the accuracy of synchronisation that is required for high frequency wireless systems, such GSM/UMTS (Global System for Mobile Communications/Universal Mobile Telecommunications System) residential basestations. These approaches are also applicable for other applications such as IP Television (IPTV).

The approaches described below with reference to embodiments of the present invention, can be summarised as follows:
Deriving a timing reference from other wireless basestations
A method of providing very accurate timing over a packet network (such as IP) using only the forward link from the network to the basestation
A method of compensating the timing reference for network jitter
A method of temperature compensation of the crystal oscillator such that a low-cost crystal can be used
A method to switch between timing reference sources (basestation, IP network)
Minimise network synchronisation loading by piggybacking on to other messages

### BRIEF DESCRIPTION OF THE DRAWINGS

FIG. 1 illustrates a previously considered basestation clock synchronisation technique;

FIG. 2 illustrates basestation clock synchronisation according to one aspect of the present invention;

FIG. 3 illustrates signal transfer in a technique according to the present invention; and

FIG. 4 illustrates a data packet structure according to another aspect of the present invention.

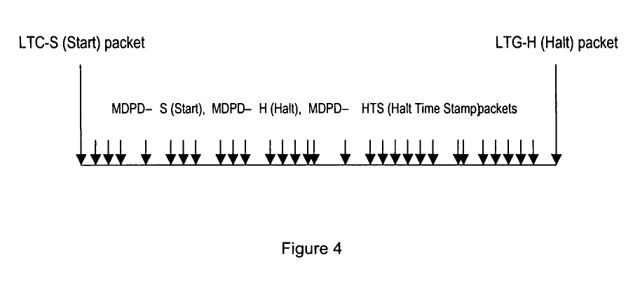

### DETAILED DESCRIPTION OF THE PREFERRED EMBODIMENTS

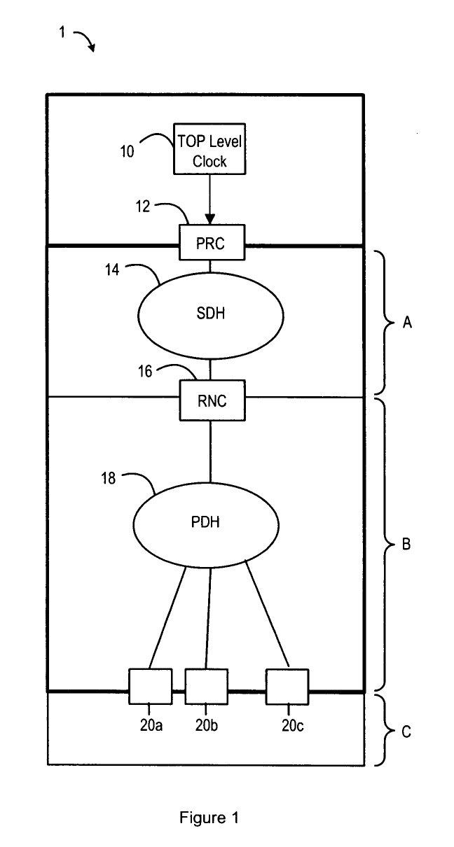

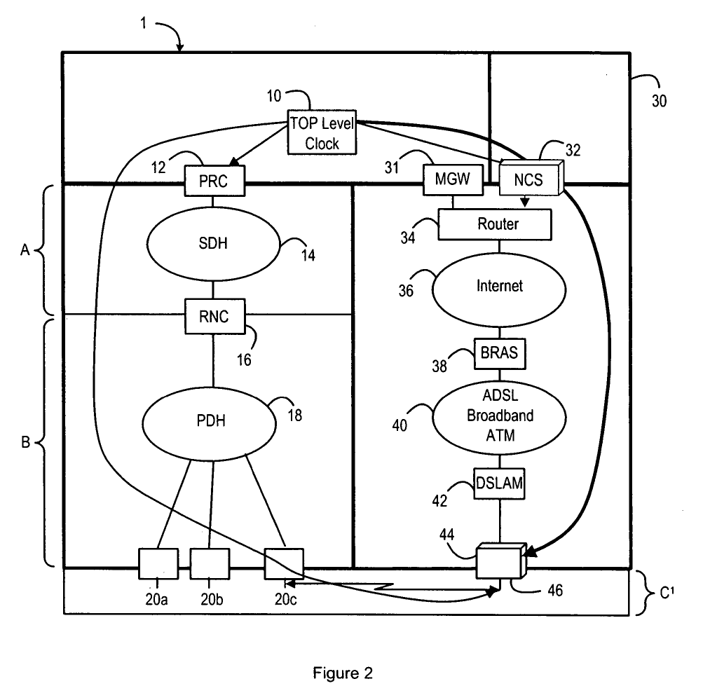

FIG. 2 illustrates a wireless telecommunications network that uses the known backhaul network shown in FIG. 1, together with a broadband IP based network. A residential basestation is shown at 44, and operates in parallel with other basestations 20a, 20b, and 20c. As before, the top-level clock 10 provides the basic timing reference for the system. It will be readily appreciated that the term “residential basestation” can include any appropriate basestation suitable for use in a wireless telecommunications network.

In the system illustrated in FIG. 2, and as is well known and understood, data is communicated between the core network using a gateway 31, and a router 34 connected to the internet 36. A Broadband Remote Access Server (BRAS) 38 connects the Internet connection with an ADSL network 40, which itself provides a broadband connection for the residential basestation 44, via a Digital Subscriber Line Access Multiplexer (DSLAM) 42.

In a first embodiment of the present invention, reference clock signal synchronisation for the residential basestation 44 is provided by reconfiguring basestation modem and RF functions to operate such that they function as a GSM/UMTS terminal device in order to recover timing synchronisation from surrounding basestations in the manner that GSM/UMTS mobile terminals achieve this. This reconfiguration is of a short duration—typically a few minutes—and the recovered timing synchronisation is used to “discipline” a crystal oscillator which retains the recovered timing accuracy for a number of hours. The modem and RF functions are then reconfigured as a basestation to provide service to mobile terminals, for example for subscribers within the home. This pattern of reconfiguration can be repeated to maintain accurate timing for basestation service. Intelligence is available within the basestation control software to prevent service impacts to users so the reconfiguration will only occur when there are no active calls and/or at likely quiet periods during the day determined by long-term observation of call patterns.

The timing synchronisation signals can be detected from any available GSM/UMTS transmission, and not just from the network to which the residential basestation is connected. Similarly, timing derived from GSM networks can be used to define UMTS basestation timing and vice versa.

In some deployment scenarios, it is not possible to derive a suitable timing synchronisation signal. For example, surrounding basestation signals may be too weak to be useable. Also, it may not be desirable to repeatedly configure the basestation as a mobile terminal for detecting the timing signal, since the configuration and reconfiguration of the basestation takes time.

In those cases, an alternative method for synchronisation is provided in which the IP network broadband connection is used to supply a timing reference signal.

Using IP as a timing reference source presents a new challenge, namely jitter, which can severely limit the feasibility of using the received data packets to provide the required level of accuracy. This challenge can be overcome according to another aspect of the present invention, by accurately timestamping a first (or start) data packet indicating when the data packet was sent from the core network to the basestation. This timestamp is sent over the IP layer, using a network clock server (NCS) 32.

In order to calibrate the basestation clock frequency, the basestation uses a timer or counter which is started upon reception of a start data packet, and is stopped upon reception of a stop data packet.

The basestation local clock runs asynchronously to that of the network clock, that is, excluding errors due to jitter, the basestation may count more or less time between the network start and stop data packets than the difference between the received start and stop timestamps which are generated by the network clock.

Using a radio network frequency synchronisation pulse from a surrounding basestation, the residential basestation clock can be synchronised, resulting in the ability to measure the jitter between the network start and stop packets with an accuracy of, for example, 50 ppb. The basestation counter can then be calibrated by calculating the difference between the counted time difference, and the time difference indicated by the time stamped start and stop data packets. This difference is the jitter time, which can be used to accurately compensate for jitter, thereby accurately synchronising to the NCS clock timestamp.

If the residential basestation cannot detect a macro cell basestation synchronisation signal then it proceeds to use a second method of synchronisation. This method is to measure the amount of clock pulses over a given time period; longer measurement periods will result in greater accuracy. As start/stop packets may be lost, the residential basestation can decide when to start the long-term timer/counter of its clock. If the residential basestation had previously been synchronised to a wireless basestation synchronisation signal then the residential basestation can decide to synchronise using a short time between a single start-stop data packet duplets.

The NCS 32 sends start and stop packet continuously, the interval between these packets can be adjusted to manage the network loading created by the packets and residential basestation accuracy required. While the residential basestation is integrating its clock between a given NCS start packet (for example packet 1) and stop packet (for example packet 1000), the time between each start and stop packet pair is measured and the jitter time noted. Over the long-term integration period, the jitter between the start-stop pairs will be distributed in time, between the least delayed (minimum jitter) and longest delayed (maximum jitter). After the long-term integration is completed, the amount of time correction needed to compensate for the jitter can be calculated.

The method of using the least amount of jitter time for residential basestation timing synchronisation means that the propagation delay from the NCS 32 to the basestation 44 is not required as is the case in many other synchronisation processes. Over time, the minimum jitter delay will approximate to propagation delay.

Apart from jitter, the residential basestation clock reference frequency can vary with temperature. In embodiments of the present invention, the amount of clock frequency deviation from nominal per degree centigrade is characterised. This information is stored in memory in the basestation so that it can be accessed to enable the frequency deviation due to temperature to be compensated. A temperature measurement device is included in the basestation. Periodically, the temperature is measured and the temperature is used to index the frequency deviation stored in memory. The deviation value is then used to adjust the crystal oscillator either directly or by a compensation factor applied to the start packet/stop pack timing measurements which will indirectly adjust the oscillator.

Once the crystal oscillator has been compensated for temperature, and the long term integration of start and stop packets used to compensate for jitter, the residential basestation clock can be synchronised with the network clock. Synchronisation can then be achieved by comparing the time between the start and stop data packets received from the network and the time counted by the basestation timer/counter. Any difference will initiate appropriate adjustment of the basestation's crystal oscillator to obtain synchronisation to the network clock. Note that in this application only frequency accuracy is a concern—the basestation does not have to be fully phase synchronous with the network clock.

As synchronisation packets can increase the packet loading on the network, a method is proposed to reduce this loading in which synchronisation messages (timestamps) are transmitted within other messages such as “keep-alive” messages.

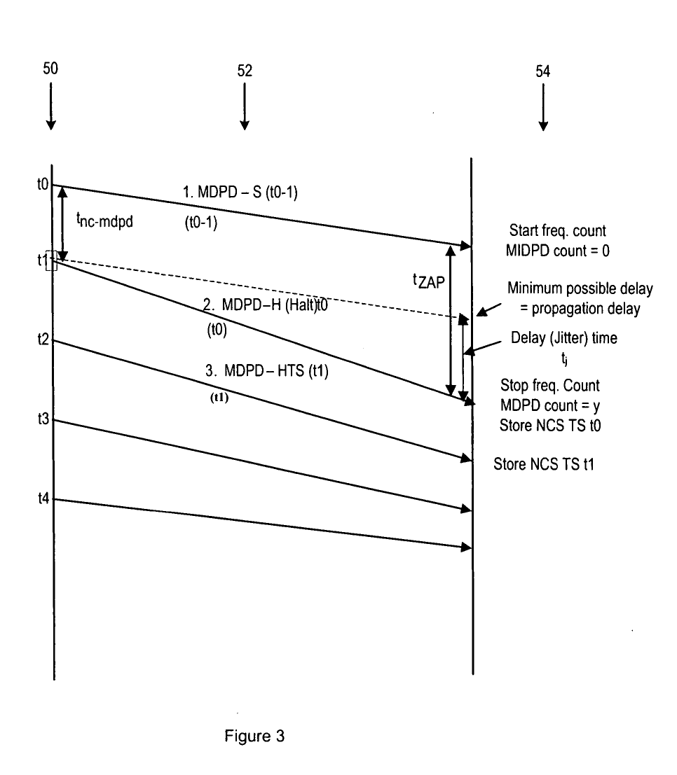

FIG. 3 illustrates packet transfer from the NCS 32 to the residential basestation 44. The arrowed lines 52 illustrate the timing of packets being sent 50 at times t0, t1 etc from the NCS 32 to the home basestation 44. The packets are shown as being sent on a regular time boundary, but this need not be the case. The time period taken for the time the sloped lines in FIG. 3 illustrate stamped data packets. The steeper the angle of the slope, the greater the time delay. If the delay in the network were constant (as illustrated by the dotted line in FIG. 3) then the angles of the lines would be also be constant. This constant time delay would then represent the propagation delay of a packet transmitted from the NCS 32 to the basestation 44. Network jitter can cause the angle to vary on below that of the constant angle. It will also cause it to vary from one packet to another.

In order to derive the minimum packet arrival time, the following packet sequence is required: a start packet is sent from the NCS 32 to start the residential basestation timer counter, and a predefined time later, a stop packet is sent from the NCS 32. The stop packet causes the basestation timer counter to be stopped, and contains a timestamp of when the corresponding start packet was sent. Finally, a third packet is sent by the NCS 32 which contains a timestamp of when the stop packet was sent. The start and stop packets may each experience jitter, and, therefore, the time difference between the start-stop of the basestation timer counter and the difference between the start and stop timestamps from the NCS, represents the jitter time, inclusive of the start and stop packets. This jitter time is divided by two.

Although the result may be greater than the actual jitter of a single packet, over time both packets will experience minimum jitter. The method then determines the minimum jitter by comparing a new jitter value with the pervious jitter value, and if it is less then uses the new jitter value as the reference jitter value. The jitter discovery packets (start, stop and timestamp packets) are sent regularly, so that jitter discovery is a continuous process. This is especially useful when the characteristics of the network change over time.

The jitter discovery packets from the NCS are used by the basestation to initiate start and stop long-term measurement of the basestation clock. For example, the basestation decides to use start jitter discovery packet “x” it stores the associated NCS timestamp in memory and reads the basestation timer counter which it also stores in memory. At a pre-determined jitter packet count or time-out the basestation reads the next stop jitter discovery packet “x+n” where n is the number of packets from the first. At the same time as reading the stop jitter discovery packet NCS timestamp and storing it in memory the basestation reads its timer counter whose value is also stored.

The basestation then determines the time between its timer counter start and stop time which is stored in memory. The next step is to determine the time difference between the network NCS timestamp and the time between the basestation start and stop timer counter. The longer the time between starting (read) and stopping (read) of the basestation timer counter the better the accuracy. With a relatively large number of time delay measurements, it is possible to analyse the distribution of the jitter values, to enable jitter to be effectively compensated for. Information regarding the jitter statistics can also be used to optimise the packet buffer size, and hence to minimise latency in the packet based system.

Either the Basestation or the NCS can initiate the synchronisation process. If it is the NCS then an extra message set is defined whereas the above those defined for establishing the current minimum jitter is required, to start and stop the process.

The synchronisation process consists starting the basestation timer counter and then after a period of time stopping the timer counter. The time when the clock was started and stopped is derived from the NCS timestamp. The difference between this time and the time counted using the basestation clock is the synchronisation error which also includes jitter errors. Errors due to temperature are compensated for at each jitter measurement process.

If the temperature of the basestation shifts from a nominal value, then the reference frequency of the basestation's crystal oscillator will drift from its nominal value. In embodiments of the present invention, frequency errors for the crystal oscillator are measured over a range of temperatures. The temperatures and corresponding errors are stored in memory in the basestation.

A temperature-measuring device is incorporated in the basestation and when the temperature drifts outside of a given range, then the following temperature compensation process is initiated. This process consists of reading the temperature from the device and using that temperature to index the crystal oscillator error value stored in memory. This value is then used to adjust the crystal oscillator in order to compensate the output frequency for the temperature change.

1. A basestation for use in a wireless telecommunications system, the basestation having a reference clock signal and being operable to communicate with wireless mobile terminals and with a packet switched network, and comprising:
a detector for detecting a radio frequency clock synchronisation signal from a wireless telecommunications network; and
a synchronisation unit operable to synchronise the reference clock signal of the basestation in dependence upon a detected radio frequency clock synchronisation signal, wherein the synchronisation unit is further operable to receive clock synchronisation data packets from a packet switched network, and to synchronise the reference clock signal in dependence upon received clock synchronisation data packets.

2. A basestation as claimed in claim 1, wherein the synchronisation unit is operable to synchronise the reference clock signal using the detected radio frequency clock synchronisation signal from a macrocell basestation, or using received clock synchronisation data packets if no macrocell basestation synchronisation signal can be detected.

3. A basestation as claimed in claim 1, wherein the synchronisation unit is operable to:
receive a start data packet at the basestation;
receive a stop data packet at the basestation;
obtain timestamp information at the basestation, the information including a time indication of time period between the sending of the start data packet and the sending of the stop data packet; and
measure a time between receipt of the start data packet and the stop data packet at the basestation using a reference clock signal of the basestation;
compare the timestamp information with the measured time to produce a comparison value; and
adjust the reference clock signal of the basestation in dependence upon the generated comparison value.

4. A method of operation of a basestation in a wireless telecommunications system, the basestation generating a reference clock signal, the method comprising:
determining whether it is possible to detect a radio frequency clock synchronisation signal from a macrocell basestation of a wireless telecommunications network; and, if so:
synchronising the reference clock signal of the basestation in dependence upon the detected radio frequency clock synchronisation signal,
or, if not:
receiving clock synchronisation data packets from a packet switched network; and
synchronising the reference clock signal in dependence upon received clock synchronisation data packets.

5. A method as claimed in claim 4, wherein the step of receiving clock synchronisation data packets from the packet switched network comprises:
receiving a start data packet at the basestation;
receiving a stop data packet at the basestation; and
obtaining timestamp information at the basestation, the timestamp information including a time indication of time period between the sending of the start data packet and the sending of the stop data packet;
and the step of synchronising the reference clock signal comprises:
measuring a time between receipt of the start data packet and the stop data packet at the basestation using the reference clock signal of the basestation,
comparing the timestamp information with the measured time to produce a comparison value; and
adjusting the reference clock signal of the basestation in dependence upon the comparison value.

6. A basestation, for use in a wireless telecommunications system, the basestation being adapted to:
generate a reference clock signal;
receive a start data packet from a time server over a packet data network;
receive a stop data packet from the time server over the packet data network;
obtain timestamp information, the timestamp information including a time indication of time period between the sending of the start data packet and the sending of the stop data packet;
measure a time between receipt of the start data packet and the stop data packet at the basestation using the reference clock signal;
compare the timestamp information with the measured time to produce a comparison value; and
adjust the reference clock signal in dependence upon the generated comparison value.

7. A method for synchronising a clock signal in a basestation of a wireless telecommunications system, the basestation having an internal reference clock signal and being operable to communicate with wireless mobile terminals and with a packet switched network, the method comprising detecting a radio frequency clock synchronisation signal from a wireless telecommunications network, and synchronising the reference clock signal of the basestation in dependence upon the detected radio frequency clock synchronisation signal.

8. A method as claimed in claim 7, comprising configuring at least part of the basestation as a mobile terminal operable to obtain clock synchronisation information from a standard wireless telecommunications network.

9. A method as claimed in claim 8, comprising reconfiguring said part of the basestation as a wireless basestation following detection of the radio frequency clock synchronisation signal.

10. A method as claimed in any of claims 7 to 9, wherein the radio frequency clock synchronisation signal is detected from a wireless network different to the wireless network to which the basestation is connected.

11. A method as claimed in claim 7, comprising receiving clock synchronisation data packets from the packet switched network, and synchronising the reference clock signal using the radio frequency clock synchronisation signal in combination with the received clock synchronisation data packets.

12. A method as claimed in claim 11, comprising initially synchronising the reference clock signal using the detected radio frequency clock synchronisation signal, and subsequently using received clock synchronisation data packets to maintain reference clock synchronisation, wherein a radio frequency clock synchronisation signal is detected and used for synchronisation if receipt of the clock synchronisation data packets is interrupted.

13. A method as claimed in claim 11, wherein synchronising the reference clock frequency using received clock synchronisation packets includes the steps of:
receiving a start data packet at the basestation;
starting a timer upon receipt of the start data packet;
receiving a stop data packet at the basestation;
stopping the timer upon receipt of the stop data packet to generate a timer value; obtaining timestamp information at the basestation, the information including a time indication of time period between the sending of the start data packet and the sending of the stop data packet; and
comparing the timestamp information with the timer value to produce a comparison value; and
adjusting the reference frequency of the base station in dependence upon the generated comparison value.

14. A method as claimed in claim 13, wherein the timestamp information is derived from information included in the start data packet and the stop data packet.

15. A method as claimed in claim 13, wherein the timestamp information is included in a timestamp data packet received by the basestation.

16. A method as claimed in claim 11, wherein the synchronising the reference clock signal does not require transmission of feedback data packets from the basestation to the packet switched network.

17. A method as claimed in any of claims 7 to 9, wherein the packet switched network is an Internet protocol based network.

18. A basestation for use in a wireless telecommunications system, the basestation having a reference clock signal and being operable to communicate with wireless mobile terminals and with a packet switched network, and comprising:
a detector for detecting a radio frequency clock synchronisation signal from a wireless telecommunications network; and
a synchronisation unit operable to synchronise the reference clock signal of the basestation in dependence upon a detected radio frequency clock synchronisation signal.

19. A basestation as claimed in claim 18, comprising synchronisation unit is operable to configure at least part of the basestation as a mobile terminal operable to obtain clock synchronisation information from a standard wireless telecommunications network.

20. A basestation as claimed in claim 19, wherein the synchronisation unit is operable to reconfigure said part of the basestation as a wireless basestation following detection of the radio frequency clock synchronisation signal.

21. A basestation as claimed in any one of claims 18 to 20, wherein the radio frequency clock synchronisation signal is detected from a wireless network different to the wireless network to which the basestation is connected.

22. A basestation as claimed in claim 18, wherein the synchronisation unit is operable to receive clock synchronisation data packets from a packet switched network, and to synchronise the reference clock signal using a radio frequency clock synchronisation signal in combination with received clock synchronisation data packets.

23. A basestation as claimed in claim 22, wherein the synchronisation unit is operable to synchronise the reference clock signal initially using the detected radio frequency clock synchronisation signal, and subsequently using received clock synchronisation data packets to maintain reference clock synchronisation, and to detect and use a radio frequency clock synchronisation signal for synchronisation if receipt of the clock synchronisation data packets is interrupted.

24. A basestation as claimed in claim 22, wherein the synchronisation unit is operable to:
receive a start data packet at the basestation;
start a timer upon receipt of the start data packet;
receive a stop data packet at the basestation;
stop the timer upon receipt of the stop data packet to generate a timer value; obtain timestamp information at the basestation, the information including a time indication of time period between the sending of the start data packet and the sending of the stop data packet; and
compare the timestamp information with the timer value to produce a comparison value; and
adjust the reference clock signal of the basestation in dependence upon the generated comparison value.

25. A basestation as claimed in claim 24, wherein the timestamp information is derived from information included in the start data packet and the stop data packet.

26. A basestation as claimed in claim 24, wherein the timestamp information is included in a timestamp data packet received by the basestation.

27. A basestation as claimed in any one of claims 22, wherein the basestation is not operable to transmit feedback data packets to the packet switched network following reception of clock synchronisation data packets therefrom.

28. A basestation as claimed in any one of claims 18 to 20, wherein the packet switched network is an Internet protocol based network

29. A method for synchronising a clock signal in a basestation of a wireless telecommunications system, the basestation having an internal reference clock signal, and being operable to communicate with wireless mobile terminals and with a packet switched network, the method comprising receiving clock synchronisation data packets transmitted from the packet switched network, and synchronising the reference clock signal of the basestation in dependence upon the received clock synchronisation packets, wherein the method does not require transmission of feedback data packets from the basestation to the packet switched network.

30. A method as claimed in claim 29, wherein the packet switched network is an Internet protocol based network.

31. A method as claimed in claim 29, comprising the steps of:
receiving the start data packet at the basestation;
starting a timer upon receipt of the start data packet;
receiving the stop data packet at the basestation;
stopping the timer upon receipt of the stop data packet to generate a timer value;
obtaining timestamp information at the basestation, the information including a time indication of time period between the sending of the start data packet and the sending of the stop data packet; and
comparing the timestamp information with the timer value to produce a comparison value; and
adjusting the reference frequency of the base station in dependence upon the generated comparison value.

32. A method as claimed in claim 31, wherein the timestamp information is derived from information included in the start data packet and the stop data packet.

33. A method as claimed in claim 31, wherein the timestamp information is included in a timestamp data packet received by the basestation.

34. A method as claimed in claim 29, wherein the timestamp information is derived from information included in the start data packet and the stop data packet.

35. A method as claimed in claim 29, wherein the timestamp information is included in a timestamp data packet received by the basestation.

36. A basestation for use in a wireless telecommunications system, the basestation having an internal reference clock signal, and being operable to communicate with wireless mobile terminals and with a packet switched network, and comprising a synchronisation unit operable to receive clock synchronisation data packets transmitted from the packet switched network, and to synchronise the reference clock signal of the basestation in dependence upon received clock synchronisation packets, synchronising the reference clock signal does not require transmission of feedback data packets to the packet switched network.

37. A basestation as claimed in claim 36, wherein the packet switched network is an Internet protocol based network.

38. A basestation as claimed in claim 36 or 37, wherein the synchronisation unit is operable to:
receive a start data packet at the basestation;
start a timer upon receipt of the start data packet;
receive a stop data packet at the basestation;
stop the timer upon receipt of the stop data packet to generate a timer value; obtain timestamp information at the basestation, the information including a time indication of time period between the sending of the start data packet and the sending of the stop data packet; and
compare the timestamp information with the timer value to produce a comparison value; and
adjust the reference clock signal of the base station in dependence upon the generated comparison value.
